(19) United States
(12) Patent Application Publication
(10) Pub. No.: US 2014/0061436 A1
(43) Pub. Date: Mar. 6, 2014

(54) SOLID STATE IMAGING DEVICE

(71) Applicant: Canon Kabushiki Kaisha, Tokyo (JP)

(72) Inventor: Masahiro Kobayashi, Tokyo (JP)

(73) Assignee: Canon Kabushiki Kaisha, Tokyo (JP)

(21) Appl. No.: 13/971,511

(22) Filed: Aug. 20, 2013

(30) Foreign Application Priority Data
Sep. 4, 2012 (JP) 2012-194182

(51) Int. Cl. H04N 5/369

(52) U.S. Cl. CPC H04N 5/369
USPC 250/208.1

(57) ABSTRACT

A solid state imaging device includes: first and second photoelectric conversion units to generate charges; a isolation portion to isolate the photoelectric conversion units; first and second floating diffusions; first and second transfer transistors to transfer the generated charges to the floating diffusions; one or two transfer control lines to supply transfer pulses to the transfer transistors; one or two contacts to connect gates of the transfer transistors with the transfer control lines, wherein: the first and second transfer transistors are symmetrical with respect to the isolation portion; the contacts are symmetrical with respect to the isolation portion; values of parasitic capacitance and resistance of paths in which the transfer pulses are supplied from the transfer control lines to (i) the first and (ii) the second transfer transistors are equal; and a focus detection is performed using signals based on charges generated in the photoelectric conversion units.

### BACKGROUND OF THE INVENTION

1. Field of the Invention

The present invention relates to a solid state imaging device.

2. Description of the Related Art

Digital cameras and digital camcorders adopt a solid state imaging device, such as CMOS imaging device, where a plurality of photoelectric conversion units is two-dimensionally arranged. There is a technique that divides each pixel of the solid state imaging device for use for phase difference focus detection and a three-dimensional image utilizing parallax. U.S. Patent Application Publication No. 2010/0133590 (hereinafter, called Patent Document 1) discloses a configuration that divides a photodiode (hereinafter, abbreviated as PD) in one pixel into multiple parts. Japanese Patent Application Laid-Open No. 2001-250931 (hereinafter, called Patent Document 2) discloses a configuration that compares outputs of two PDs with each other to perform focus detection using an image pickup lens.

Arrangement of a plurality of transfer units in a plurality of PDs allows transfer from the PD to a floating diffusion (hereinafter, abbreviated as FD) to be performed simultaneously. Use of signals read from the PD can improve functionality of the solid state imaging device. Unfortunately, in the case of using the signals read from the different transfer units as independent signals, only with simple symmetrical arrangement of transfer transistors as with Patent Document 1, a deviation in readout timing causes a difference in readout signal level. Accordingly, correct signal processing is difficult.

It is an object of the present invention to provide a solid state imaging device that can prevent aliasing due to deviation in transfer timing of a plurality of transfer transistors.

### SUMMARY OF THE INVENTION

A solid state imaging device of the present invention includes: a first photoelectric conversion unit configured to generate electric charges by photoelectric conversion; a second photoelectric conversion unit configured to generate electric charges by photoelectric conversion; a isolation portion configured to isolate the first photoelectric conversion unit from the second photoelectric conversion unit; a first floating diffusion; a second floating diffusion; a first transfer transistor configured to transfer the electric charges generated by the first photoelectric conversion unit to the first floating diffusion; a second transfer transistor configured to transfer the electric charges generated by the second photoelectric conversion unit to the second floating diffusion; one or two transfer control lines configured to supply transfer pulses to each of the first and second transfer transistors; one or two contacts configured to connect gates of the first and second transfer transistors with the one or two transfer control lines, wherein: the first and second transfer transistors are arranged substantially symmetrically with respect to the isolation portion; the contacts are arranged substantially symmetrically with respect to the isolation portion; values of parasitic capacitance and parasitic resistance of a path in which the transfer pulses are supplied from the transfer control lines to the first transfer transistor is substantially equal to values of parasitic capacitance and parasitic resistance of a path in which the transfer pulses are supplied from the transfer control lines to the second transfer transistor; and a focus detection is performed using a signal based on electric charges generated in the first photoelectric conversion unit and a signal based on electric charges generated in the second photoelectric conversion unit.

Further features of the present invention will become apparent from the following description of exemplary embodiments with reference to the attached drawings.

### BRIEF DESCRIPTION OF THE DRAWINGS

FIG. 1 is a block diagram of a solid state imaging device according to First Embodiment.

FIG. 2 is a circuit diagram of pixels of the solid state imaging device according to First and Second Embodiments.

FIG. 3 is a planar layout diagram of the pixels of the solid state imaging device according to First Embodiment.

FIG. 4 is a timing chart of the solid state imaging device of First and Second Embodiments.

FIGS. 5A, 5B and 5C are potential diagrams of the solid state imaging device according to First to Fourth Embodiments.

FIGS. 6A and 6B are circuit diagrams of the solid state imaging device according to First and Second Embodiments.

FIG. 7 is a planar layout diagram of the pixels of the solid state imaging device according to Second Embodiment.

FIG. 8 is a circuit diagram of the pixels of the solid state imaging device according to Third and Fourth Embodiments.

FIG. 9 is a planar layout diagram of the pixels of the solid state imaging device according to Third Embodiment.

FIG. 10 is a timing chart of the solid state imaging device according to Third and Fourth Embodiments.

FIG. 11 is a planar layout diagram of the pixels of the solid state imaging device according to Fourth Embodiment.

FIG. 12 is a planar layout diagram of pixels of a solid state imaging device according to Fifth Embodiment.

FIG. 13 is a planar layout diagram of pixels of a solid state imaging device according to Sixth Embodiment.

FIG. 14 is a planar layout diagram of pixels of a solid state imaging device according to Seventh Embodiment.

### DESCRIPTION OF THE EMBODIMENTS

Preferred embodiments of the present invention will now be described in detail in accordance with the accompanying drawings.

### First Embodiment

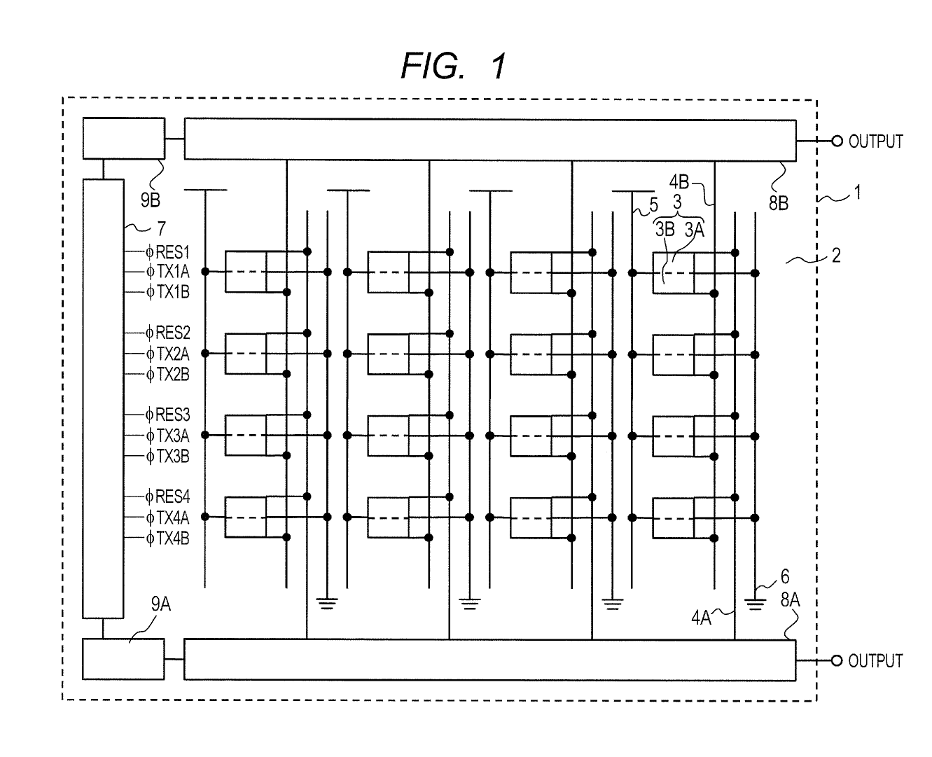

FIG. 1 is a block diagram illustrating a configurational example of a solid state imaging device 1 according to First Embodiment of the present invention. FIG. 1 does not illustrate various control lines from a vertical scanning circuit 7 to a pixel array 2, in consideration of the purpose of illustrating the configuration of this embodiment. In general, the number of actual arrayed pixels 3 belonging to the pixel array 2 is large. However, only first to fourth columns among multiple columns are exemplified, and only pixels 3 in the first to fourth rows are illustrated among the multiple pixels 3 belonging to the columns.

The solid state imaging device 1 includes the pixel array 2, the vertical scanning circuit 7, horizontal scanning and signal processing circuits 8A and 8B, and timing control circuits 9A and 9B. In the pixel array 2, the plurality of pixels 3 is arranged in a matrix. Each pixel 3 includes a pair of an upper pixel 3A and a lower pixel 3B. Each of the pixels 3A and 3B generates signals by photoelectric conversion. A signal output line 4A is connected to the pixel 3A; signals of the pixel 3A are output from this line. A signal output line 4B is connected to the pixel 3B; signals of the pixel 3B are output from this line. A power supply line 5 and a ground line 6 are connected to the pixels 3 in each column, for operating the pixels 3 in the matrix. The horizontal scanning and signal processing circuit 8A is connected to the signal output lines 4A, and sequentially and selectively activates the signal output lines 4A, thereby sequentially processing signals of the signal output lines 4A. The horizontal scanning and signal processing circuit 8B is connected to the signal output lines 4B, and sequentially and selectively activates the signal output lines 4B, thereby sequentially processing signals of the signal output lines 4B. Each of the horizontal scanning and signal processing circuits 8A and 8B includes a noise removing circuit, an amplification circuit and an analog-to-digital conversion circuit, and sequentially outputs processed signals. The timing control circuit 9A controls the timings of the vertical scanning circuit 7 and the horizontal scanning and signal processing circuit 8A. The timing control circuit 9B controls the timings of the vertical scanning circuit 7 and the horizontal scanning and signal processing circuit 8B.

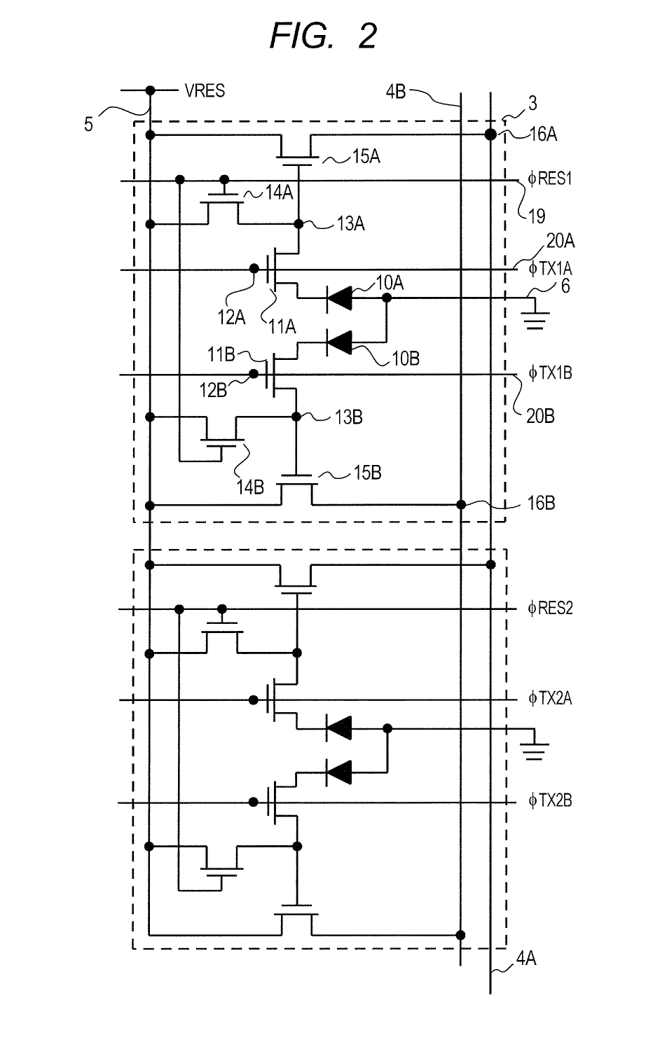

FIG. 2 is a circuit diagram illustrating a configurational example of the pixels 3 in FIG. 1. The pixel 3 includes the pixels 3A and 3B, as described above. The pixel 3A includes a first photodiode 10A, a first transfer transistor 11A, a first floating diffusion 13A, a reset transistor 14A and an amplification transistor 15A. The pixel 3B includes a second photodiode 10B, a second transfer transistor 11B, a second floating diffusion 13B, a reset transistor 14B and an amplification transistor 15B. A contact 12A is connected to the gate of the first transfer transistor 11A. The contact 12B is connected to the gate of the second transfer transistor 11B. A pixel signal output unit 16A is connected to a signal output line 4A. A pixel signal output unit 16B is connected to the signal output line 4B. The power supply line 5 and the ground line 6 are connected to the pixels 3. A reset control line 19 supplies the gates of the reset transistors 14A and 14B with reset pulses φRES1. A transfer control line 20A supplies the gate of the first transfer transistor 11A with transfer pulses φTX1A. A transfer control line 20B supplies the gate of the second transfer transistor 11B with transfer pulses φTX1B.

The first photodiode 10A is a first photoelectric conversion unit that generates electric charges by photoelectric conversion. The second photodiode 10B is a second photoelectric conversion unit that generates electric charges by photoelectric conversion. The floating diffusions 13A and 13B are regions for accumulating electric charges. The first transfer transistor 11A transfers the electric charges generated by the first photodiode 10A to the first floating diffusion 13A. The second transfer transistor 11B transfers the electric charges generated by the second photodiode 10B to the second floating diffusion 13B.

When the transfer pulses φTX1A become a high level, the first transfer transistor 11A is turned on, which connects the first photodiode 10A to the first floating diffusion 13A. When the transfer pulses φTX1B become the high level, the second transfer transistor 11B is turned on, which connects the second photodiode 10B to the second floating diffusion 13B. When the reset pulses φRES1 become the high level, the reset transistors 14A and 14B are turned on, which resets the photodiodes 10A and 10B and the floating diffusions 13A and 13B. When the transfer pulses φTX1A become a low level to turn off the first transfer transistor 11A, the first photodiode 10A starts to accumulate the signal generated by photoelectric conversion. The transfer pulses φTX1A are set to the high level, thereby turning on the first transfer transistor 11A, which transfers the signal of the first photodiode 10A to the first floating diffusion 13A. The amplification transistor 15A amplifies the voltage of the first floating diffusion 13A and outputs the amplified voltage to the signal output line 4A. Likewise, when the transfer pulses φTX1B become the low level to turn off the second transfer transistor 11B, the second photodiode 10B starts to accumulate the signal generated by photoelectric conversion. The transfer pulses φTX1B are set to the high level, thereby turning on the second transfer transistor 11B, which transfers the signal of the second photodiode 10B to the second floating diffusion 13B. The amplification transistor 15B amplifies the voltage of the second floating diffusion 13B and outputs the amplified voltage to the signal output line 4B.

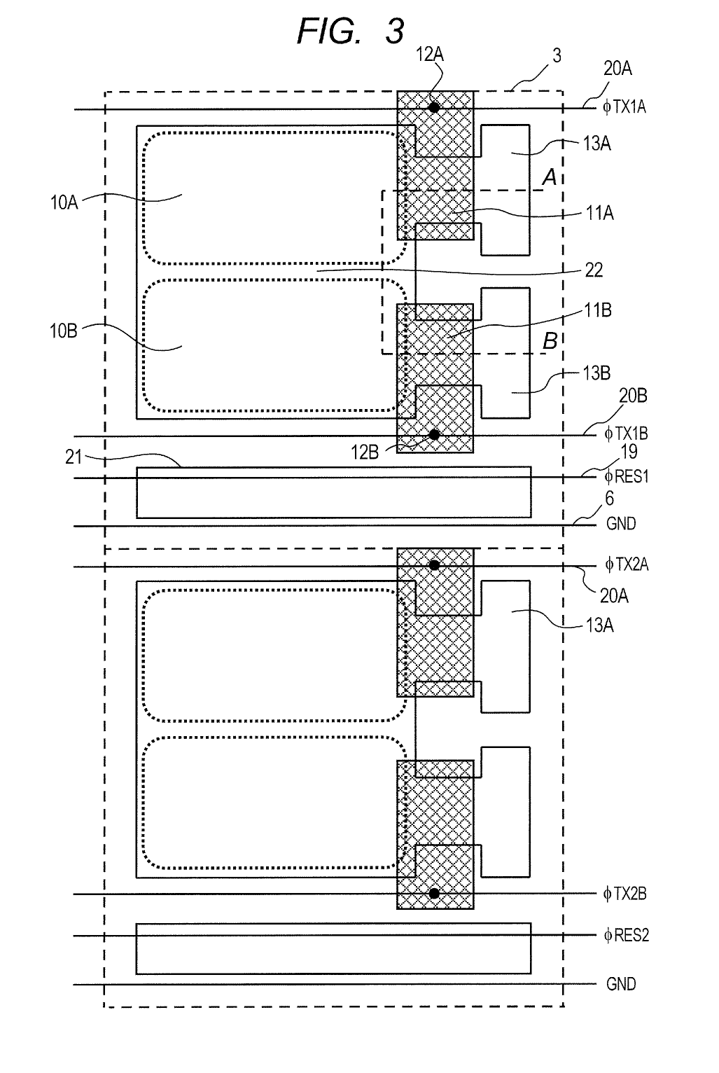

FIG. 3 is a planar layout diagram illustrating a principal part of the pixels 3 in FIG. 2. FIG. 3 only illustrates the pixels 3A and 3B belonging to the first column and the first row in the matrix of the pixels 3 in the pixel array 2, in consideration of the purpose illustrating the configuration of this embodiment. Furthermore, the signal output lines 4A and 4B and the power supply line 5 arranged in the vertical direction of the pixels 3 are not illustrated, and the contacts corresponding to the reset control line 19, the power supply line 5 and the ground line 6 are not illustrated. Readout units after the floating diffusions 13A and 13B are collectively illustrated as a readout unit 21. The contact 12A is a contact from the transfer control line 20A to the first transfer transistor 11A. The contact 12B is a contact from the transfer control line 20B to the second transfer transistor 11B. An isolation portion 22 isolates the first photodiode 10A from the second photodiode 10B. Here, with respect to the isolation portion 22 residing between the photodiodes 10A and 10B, the transfer transistors 11A and 11B, the contacts 12A and 12B, and the transfer control lines 20A and 20B are symmetrically or substantially symmetrically arranged. The contacts 12A and 12B are arranged at the same positions in the horizontal direction on the semiconductor substrate. The reset control line 19 and the ground line 6 are arranged at symmetrical positions or substantially symmetrical positions between the transfer control line 20B and the transfer control line 20A below the line 20B. This arrangement can suppress the difference in parasitic capacitance and parasitic resistance between the transfer control lines 20A and 20B, thereby allowing the difference in time constant to be reduced. That is, the values of parasitic capacitance and parasitic resistance of a path which range from the transfer control line 20A to the transfer transistor 11A and to which transfer pulses φTX1A are supplied are substantially identical to the values of parasitic capacitance and parasitic resistance of a path which range from the transfer control line 20B to the transfer transistor 11B and to which transfer pulses φTX1B are supplied.

The solid state imaging device 1 is provided on the semiconductor substrate. Each of the photodiodes 10A and 10B is a photoelectric conversion unit that performs photoelectric conversion, and includes a first conductive type (P-type) semiconductor region, and a second conductive type semiconductor region (N-type electron accumulation region) that configures a PN junction together with the semiconductor region of the first conductive type. The second conductive type semiconductor region of the first photodiode 10A is isolated by the isolation portion 22 from the second conductive type semiconductor region of the second photodiode 10B. One microlens is arranged for the second conductive type semiconductor regions of the photodiodes 10A and 10B.

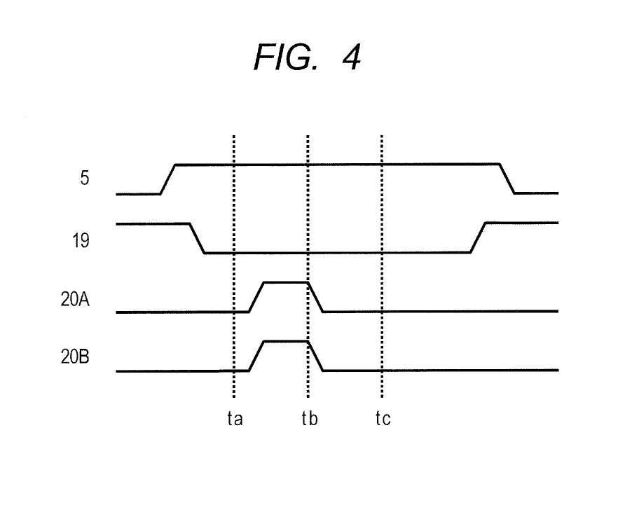

FIG. 4 is a timing chart for illustrating operation of the solid state imaging device 1. FIG. 4 illustrates voltages applied to the power supply line 5, the reset control line 19 and the transfer control lines 20A and 20B. Here, the timings of the transfer control lines 20A and 20B to be applied to the respective transfer transistors 11A and 11B are aligned with each other. After the power supply line 5 increases to the power supply voltage, the reset control line 19 is set to the high level, thereby resetting the floating diffusions 13A and 13B to the power supply voltage. On a time ta, the power supply line 5 is at the power supply voltage, the reset control line 19 is at the low level, and the transfer control lines 20A and 20B are at the low level. After the time ta, the transfer control lines 20A and 20B become the high level, and the transfer transistors 11A and 11B are turned on. The electric charges in the first photodiode 10A are transferred to the first floating diffusion 13A. The amplification transistor 15A amplitudes the voltage of the first floating diffusion 13A, and outputs the amplified voltage to the signal output line 4a. Likewise, the electric charges in the second photodiode 10B are transferred to the second floating diffusion 13B. The amplification transistor 15B amplifies the voltage of the second floating diffusion 13B, and outputs the amplified voltage to the signal output line 4a. On a time tb, the power supply line 5 is at the power supply voltage, the reset control line 19 is at the low level, and the transfer control lines 20A and 20B are at the high level. Subsequently, on a time tc, the power supply line 5 is at the power supply voltage, the reset control line 19 is at the low level, and the transfer control lines 20A and 20B are at the low level. The transfer of the electric charges is finished.

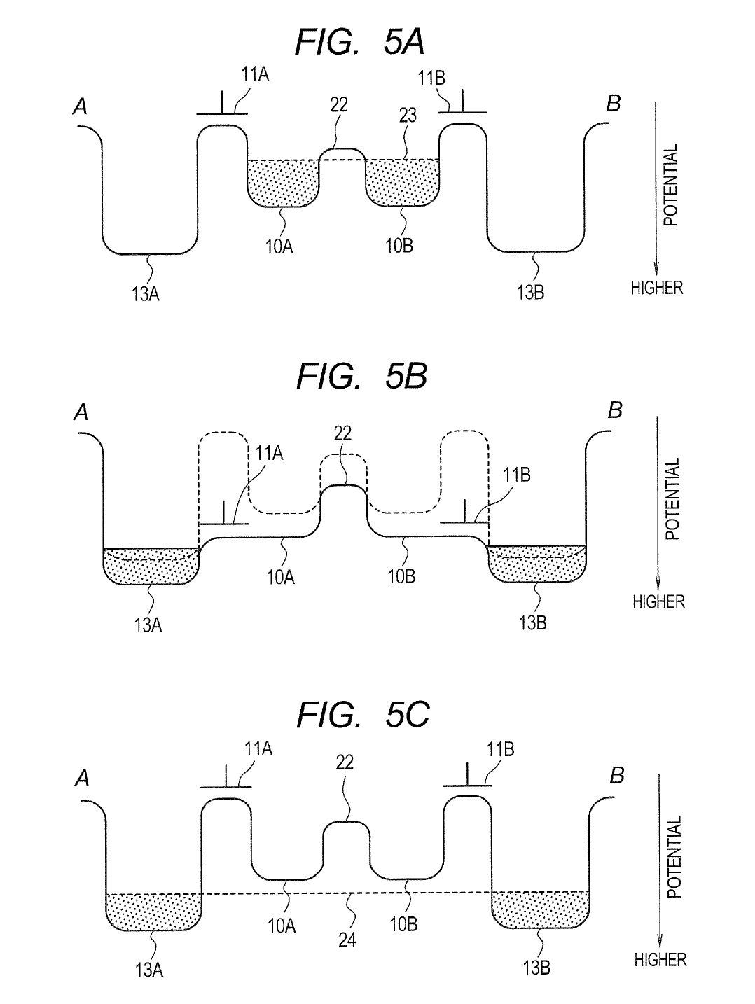

FIGS. 5A to 5C illustrate sectional potential diagrams taken along a broken line A-B in FIG. 3. FIG. 5A is a sectional potential diagram on the time to in FIG. 4. FIG. 5B is a sectional potential diagram on the time tb in FIG. 4. FIG. 5C is a sectional potential diagram on the time tc in FIG. 4.

In FIG. 5A, the transfer transistors 11A and 11B are on, signals at the signal accumulation level 23 are accumulated in the photodiodes 10A and 10B.

In FIG. 5B, the transfer transistors 11A and 11B are simultaneously turned on. The potential barriers of the transfer transistors 11A and 11B are reduced, and electric charges accumulated in photodiodes 10A and 10B are transferred to the respective floating diffusions 13A and 13B. Although the potential barrier of the isolation portion 22 is also reduced, the potential barriers of the transfer transistors 11A and 11B are sufficiently low. Accordingly, a phenomenon where the electric charges accumulated in the photodiodes 10A and 10B leak through the isolation portion 22 to the adjacent photodiodes 10A and 10B does not occur.

In FIG. 5C, both the transfer transistors 11A and 11B are off. The state of potentials returns to the state in FIG. 5A. At this time, both the signal levels of the floating diffusions 13A and 13B are a level 24. The signal difference due to leakage of electric charges does not occur.

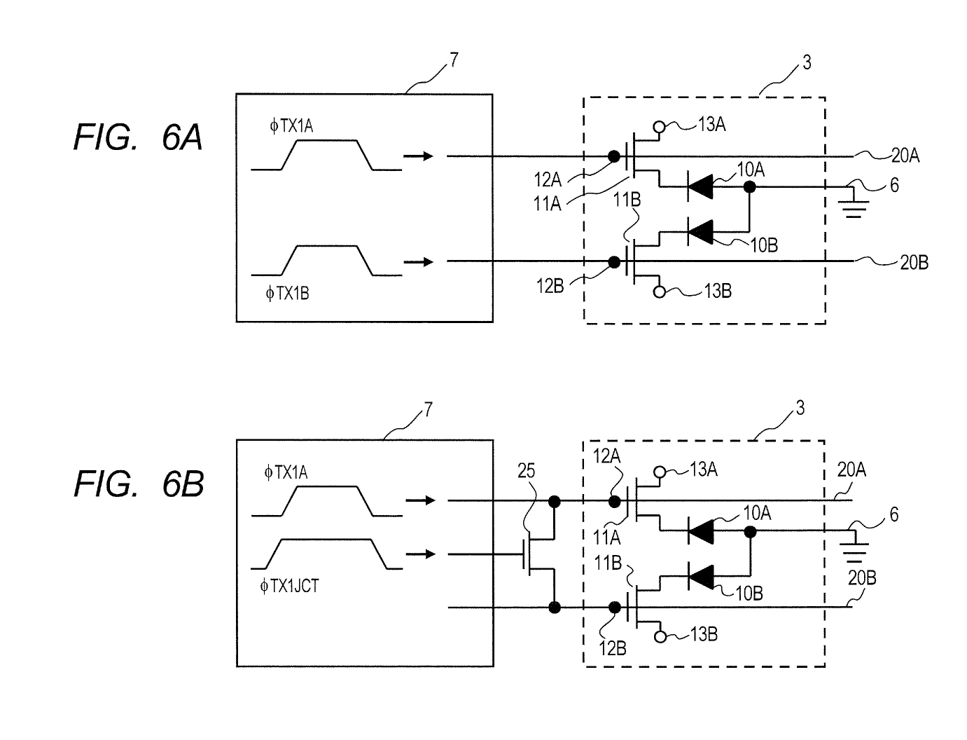

FIGS. 6A and 6B are circuit diagrams illustrating configurational examples of the vertical scanning circuit 7 and the pixels 3 in FIG. 1. In FIG. 6A, the vertical scanning circuit 7 outputs the transfer pulses φTX1A to the transfer control line 20A, and outputs the transfer pulses φTX1B to the transfer control line 20B. The transfer pulses φTX1A and φTX1B are identical to each other. Accordingly, the transfer transistors 11A and 11B simultaneously perform on/off operation.

In FIG. 6B, the pixel 3 includes a transistor (switch) 25 for connecting the transfer control lines 20A and 20B to each other. The vertical scanning circuit 7 outputs the transfer pulses φTX1A to the transfer control line 20A, and outputs control pulses φTX1JCT to the gate of the transistor 25. When the pulses φTX1A and φTX1JCT become the high level, the transistor 25 is turned on, which supplies the identical transfer pulses φTX1A to the transfer control lines 20A and 20B. The transfer transistors 11A and 11B simultaneously perform on/off operation.

In each of FIGS. 6A and 6B, the transfer transistors 11A and 11B can simultaneously operate at the same transfer pulses.

As described above, the photodiodes 10A and 10B, the transfer transistors 11A and 11B, the floating diffusions 13A and 13B, and the contacts 12A and 12B are arranged symmetrically or substantially symmetrically with respect to the isolation portion 22. Furthermore, the transfer control lines 20A and 20B are arranged symmetrically or substantially symmetrically with respect to the other lines 19 and 6. This arrangement can suppress the difference in timing delay caused between the transfer transistors 11A and 11B, and prevent electric charges from leaking. Accordingly, use of signals of the two photodiodes 10A and 10B can acquire correct signals in the case of phase difference focus detection and the case of generating a three-dimensional image using parallax, and achieve improvement in image quality and in functionality of the solid state imaging device.

### Second Embodiment

Next, a solid state imaging device according to Second Embodiment of the present invention will be described using FIGS. 1 and 2 and 4 to 7. Description on parts of this embodiment common to the parts of First Embodiment is omitted. Points of this embodiment different from those of First Embodiment will hereinafter be described.

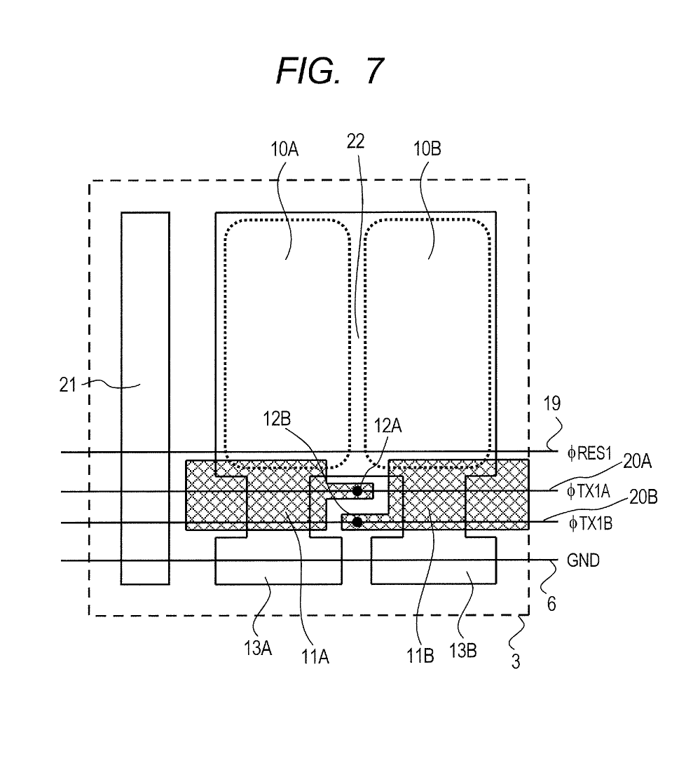

FIG. 7 corresponds to FIG. 3, and is a planar layout diagram illustrating a principal part of a solid state imaging device of Second Embodiment of the present invention. In FIG. 3, the pixel 3 is divided into the upper and lower two pixels 3A and 3B. Instead, FIG. 7 illustrates an example where the pixel 3 is divided into left and right two pixels 3A and 3B. That is, the pixel 3 in FIG. 7 is basically rotated by 90° from the pixel 3 in FIG. 3. The pixel 3 in FIG. 7 is different from the pixel 3 in FIG. 3 in that the transfer control lines 20A and 20B are arranged adjacent and in parallel to each other. With respect to the isolation portion 22 residing between the photodiodes 10A and 10B, the transfer transistors 11A and 11B, the contacts 12A and 12B, and the transfer control lines 20A and 20B are arranged symmetrically or substantially symmetrically. Furthermore, the ground line 6 and the reset control line 19 are arranged at positions symmetrical or substantially symmetrical with respect to the transfer control lines 20A and 20B.

This embodiment is different from First Embodiment only in direction of dividing the pixel 3; the other points are similar. The operation timing and variation in potential of this embodiment are similar to those in FIGS. 3 and 4; the description thereof is omitted.

The configuration illustrated in FIG. 7 can suppress the difference in parasitic capacitance and parasitic resistance between the transfer control lines 20A and 20B, thereby allowing the difference in time constant to be reduced. Adjacent and parallel arrangement of the transfer control lines 20A and 20B reduces the difference in adverse effect of lines on the upper and lower layers. Accordingly, the difference in time constant can be further reduced. As a result, this configuration can suppress the difference in timing delay caused between the transfer transistors 11A and 11B, and prevent electric charges from leaking. Accordingly, use of signals of the two photodiodes 10A and 10B can acquire correct signals in the case of phase difference focus detection and the case of generating a three-dimensional image using parallax, and achieve improvement in image quality and in functionality of the solid state imaging device.

### Third Embodiment

Next, a solid state imaging device according to Third Embodiment of the present invention will be described using FIGS. 1, 4, 5A, 5B, 8, 9 and 10. Description on parts of this embodiment common to the parts of First and Second Embodiments is omitted. Points of this embodiment different from those of First and Second Embodiments will hereinafter be described.

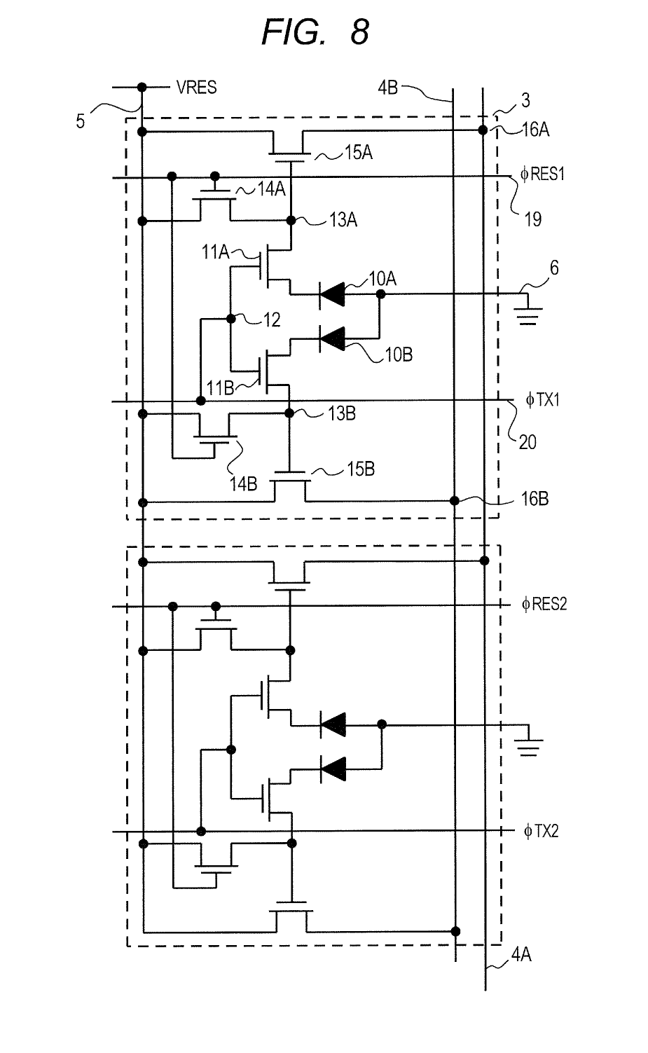

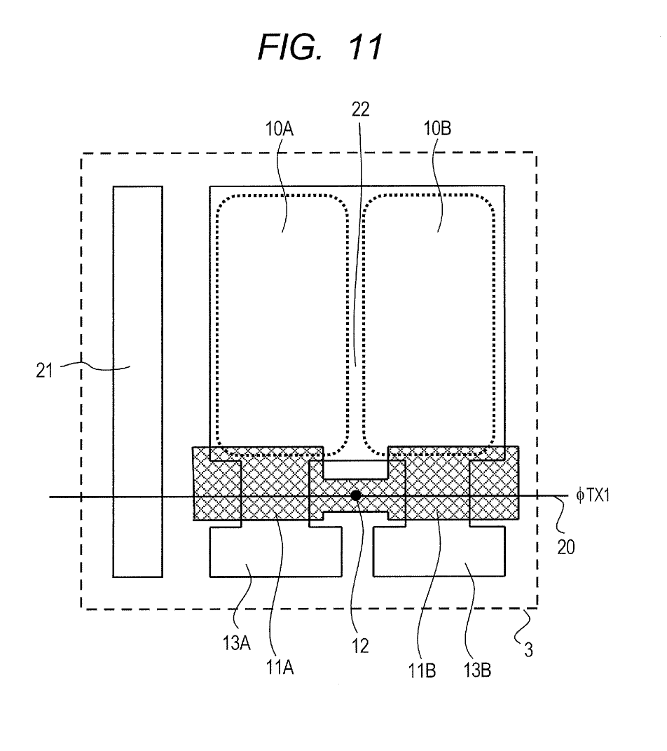

FIG. 8 corresponds to FIG. 2, and is a circuit diagram illustrating a configurational example of a pixel 3 of Third Embodiment of the present invention. FIG. 10 corresponds to FIG. 4, and is a timing chart for illustrating operation of the solid state imaging device 1. The pixel 3 in FIG. 8 is different from the pixel 3 in FIG. 2 in the following points. The two transfer control lines 20A and 20B in FIG. 2 are integrated into one transfer control line 20 in FIG. 8. The two contacts 12A and 12B in FIG. 2 are integrated into one contact 12 in FIG. 8. The differences of the pixel 3 in FIG. 8 from the pixel 3 in FIG. 2 will hereinafter be described. The transfer pulses φTX1 are supplied to the transfer control line 20. The transfer control line 20 is connected to the gates of the transfer transistors 11A and 11B. This embodiment is effective for the cases without necessity of transferring signals of the photodiodes 10A and 10B at different timings. The integration of the transfer control line 20 can reduce the number of transfer control lines arranged in the horizontal direction, increase the aperture ratio, and improve the image quality. The increase in line spacing can improve the yield rate, thereby allowing the cost to be reduced. In contrast to the case in FIG. 2, there is no need to consider the difference in parasitic resistance and parasitic capacitance occurring between the transfer control lines 20A and 20B, which in turn negates the need of limitation in FIGS. 6A and 6B.

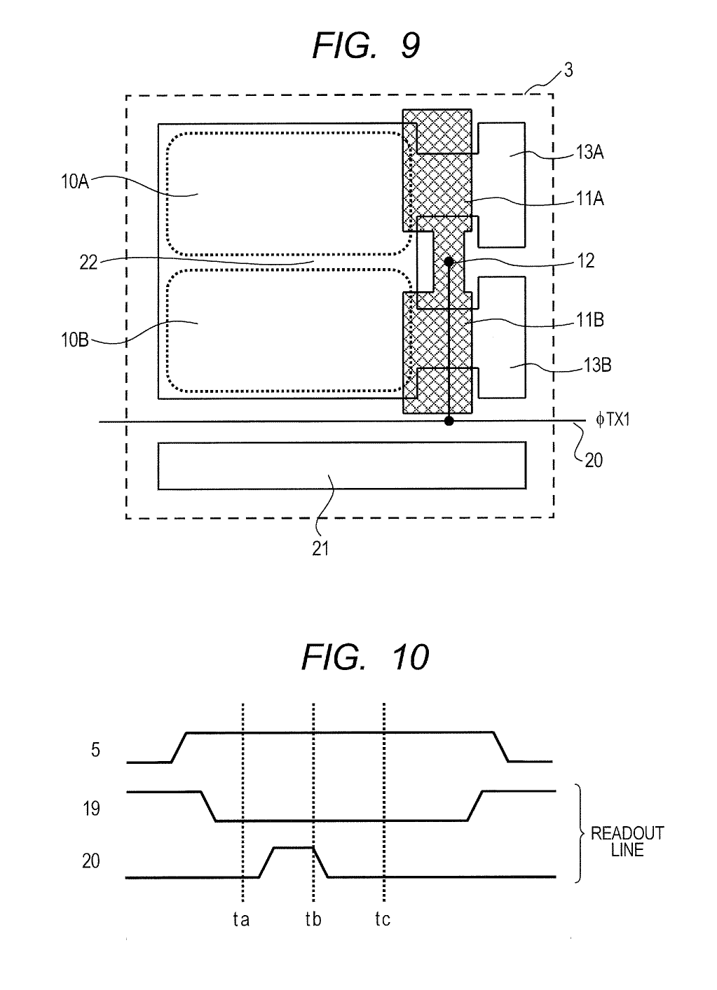

FIG. 9 is a planar layout diagram illustrating a principal part of the pixel in FIG. 8. Description on the parts in FIG. 9 common to the parts in FIG. 3 is omitted. In FIG. 9, the gates of transfer transistors 11A and 11B are connected to each other, and thus integrated. A transfer control line 20 is connected to the gates of the transfer transistors 11A and 11B at a contact 12, which resides at an extension from the isolation portion 22.

This embodiment can suppress the difference in timing delay caused between the transfer transistors 11A and 11B, and prevent electric charges from leaking. Accordingly, use of signals of the two photodiodes 10A and 10B can acquire correct signals in the case of phase difference focus detection and the case of generating a three-dimensional image using parallax, and achieve improvement in image quality and in functionality of the solid state imaging device.

### Fourth Embodiment

Next, a solid state imaging device according to Fourth Embodiment of the present invention will be described using FIGS. 1, 4, 5A, 5B, 8, 10 and 11. Description on parts of this embodiment common to the parts of First to Third Embodiments is omitted. Points of this embodiment different from those of First to Third Embodiments will hereinafter be described.

FIG. 11 corresponds to FIG. 9, and is a planar layout diagram illustrating a principal part of a pixel 3 according to Fourth Embodiment of the present invention. In FIG. 9, the pixel 3 is divided into the upper and lower two pixels 3A and 3B. Instead, FIG. 11 illustrates an example where the pixel 3 is divided into left and right two pixels 3A and 3B. That is, the pixel 3 in FIG. 11 is basically rotated by 90° from the pixel 3 in FIG. 9. As with Third Embodiment, this embodiment has a configuration where the gates of the transfer transistors 11A and 11B are integrated, and connected to the common transfer control line 20. This configuration can increase the aperture and reduce the cost.

This embodiment can suppress the difference in timing delay caused between the transfer transistors 11A and 11B, and prevent electric charges from leaking. Accordingly, use of signals of the two photodiodes 10A and 10B can acquire correct signals in the case of phase difference focus detection and the case of generating a three-dimensional image using parallax, and achieve improvement in image quality and in functionality of the solid state imaging device.

### Fifth Embodiment

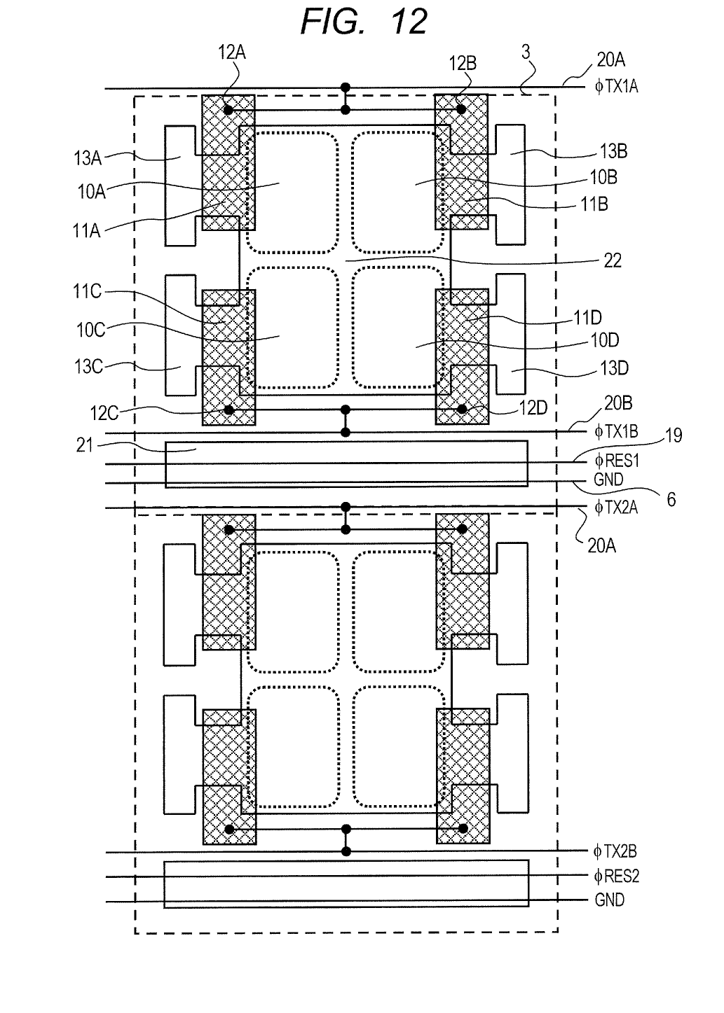

FIG. 12 corresponds to FIG. 3, and is a planar layout diagram illustrating a principal part of a pixel 3 according to Fifth Embodiment of the present invention. Points of this embodiment different from those of First Embodiment will hereinafter be described. In this embodiment, the pixel 3 is divided into four pixels. A first pixel includes a first photodiode 10A, a first transfer transistor 11A and a first floating diffusion 13A. A second pixel includes a second photodiode 10B, a second transfer transistor 11B and a second floating diffusion 13B. A third pixel includes a third photodiode 10C, a third transfer transistor 11C and a third floating diffusion 13C. A fourth pixel includes a fourth photodiode 10D, a fourth transfer transistor 11D and a fourth floating diffusion 13D.

The third photodiode 10C is a third photoelectric conversion unit that generates electric charges by photoelectric conversion. The fourth photodiode 10D is a fourth photoelectric conversion unit that generates electric charges by photoelectric conversion. The first to fourth photodiodes (first to fourth photoelectric conversion units) 10A to 10D are isolated by an isolation portion 22 from one another. Floating diffusions 13C and 13D are regions where electric charges are accumulated. A third transfer transistor 11C transfers the electric charges generated by the third photodiode 10C to the third floating diffusion 13C. A fourth transfer transistor 11D transfers the electric charges generated by the fourth photodiode 10D to the fourth floating diffusion 13D.

The transfer pulses φTX1A are supplied to the transfer control line 20A. The transfer control line 20A is connected to the gate of the first transfer transistor 11A at a contact 12A, and to the gate of the second transfer transistor 11B at a contact 12B. The transfer control line 20B is connected to the gate of the third transfer transistor 11C at a contact 12C, and to the gate of the fourth transfer transistor 11D at a contact 12D. The regions of the first and second pixels and the regions of the third and fourth pixels are symmetrical or substantially symmetrical with respect to the isolation portion 22. The regions of the first and third pixels and the regions of the second and fourth pixels are symmetrical or substantially symmetrical with respect to the isolation portion 22. That is, the first to fourth transfer transistors 11A to 11D are arranged symmetrically or substantially symmetrically with respect to the isolation portion 22. The reset control line 19 and the ground line 6 are symmetrical or substantially symmetrical between the drive control line 20B and the drive control line 20A below the line 20B.

This embodiment can suppress the difference in timing delay caused between the four transfer transistors 11A to 11D, and prevent electric charges from leaking. Accordingly, use of signals of the four photodiodes 10A to 10D can acquire correct signals in the case of phase difference focus detection and the case of generating a three-dimensional image using parallax, and achieve improvement in image quality and in functionality of the solid state imaging device.

### Sixth Embodiment

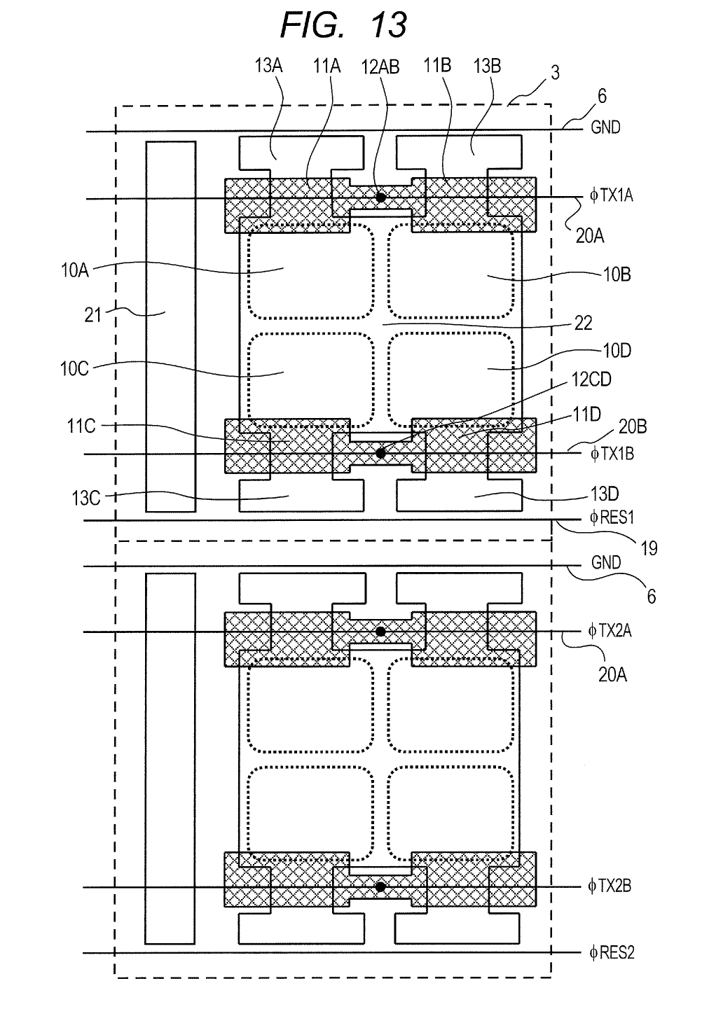

FIG. 13 corresponds to FIG. 12, and is a planar layout diagram illustrating a principal part of pixels 3 according to Sixth Embodiment of the present invention. Points of this embodiment different from those of Fifth Embodiment will hereinafter be described. The pixel 3 in FIG. 13 is basically rotated by 90° from the pixel 3 in FIG. 12. As with Third Embodiment, the gates of the transfer transistors 11A and 11B are connected to each other and thus integrated. The transfer control line 20A is connected to the gates of the transfer transistors 11A and 11B at a contact 12AB. The gates of the transfer transistors 11C and 11D are connected to each other and thus integrated. The transfer control line 20B is connected to the gates of the transfer transistors 11C and 11D at a contact 12CD.

This embodiment can suppress the difference in timing delay caused between the four transfer transistors 11A to 11D, and prevent electric charges from leaking. Accordingly, use of signals of the four photodiodes 10A to 10D can acquire correct signals in the case of phase difference focus detection and the case of generating a three-dimensional image using parallax, and achieve improvement in image quality and in functionality of the solid state imaging device.

### Seventh Embodiment

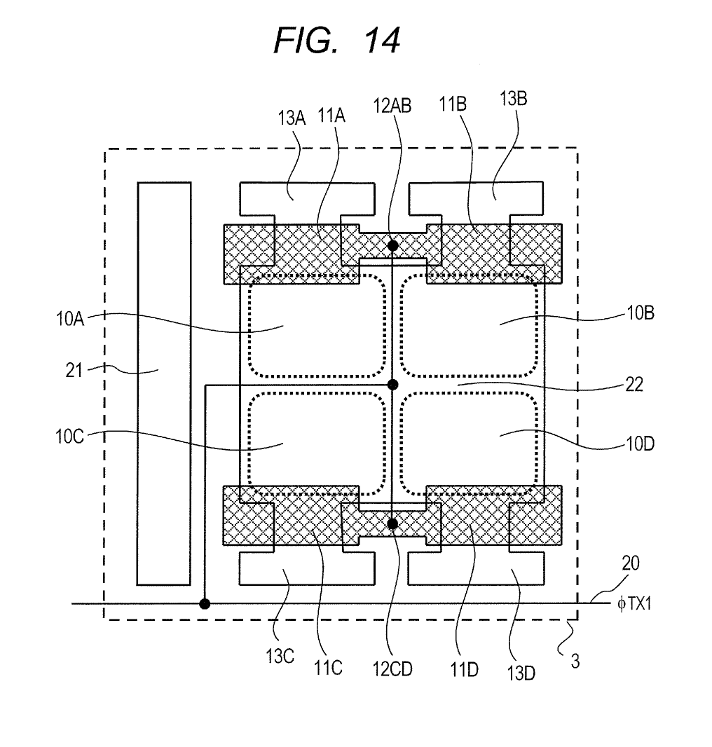

FIG. 14 corresponds to FIG. 13, and is a planar layout diagram illustrating a principal part of pixels 3 according to Seventh Embodiment of the present invention. Points of this embodiment different from those of Sixth Embodiment will hereinafter be described. As with Third Embodiment, a drive control line 20 in FIG. 14 is a line into which the two drive control lines 20A and 20B in FIG. 13 are integrated. The transfer pulses φTX1 are supplied to the drive control line 20. The drive control line 20 is connected to the common gate of the transfer transistors 11A and 11B at a contact 12AB, and to the common gate of the transfer transistors 11C and 11D at a contact 12CD. The integration of the transfer control line can reduce the number of transfer control lines and increase the aperture ratio, thereby improving the image quality. The increase in line spacing can improve the yield rate.

This embodiment can suppress the difference in timing delay caused between the four transfer transistors 11A to 11D, and prevent electric charges from leaking. Accordingly, use of signals of the four photodiodes 10A to 10D can acquire correct signals in the case of phase difference focus detection and the case of generating a three-dimensional image using parallax, and achieve improvement in image quality and in functionality of the solid state imaging device.

As with First to Seventh Embodiments, in the pixel 3, the pixel 3 is divided into the multiple photodiodes 10A to 10D, and the transfer transistors 11A to 11D, the contacts 12A to 12D and 12AB and 12CD, and the transfer control lines 20, 20A and 20B are symmetrically arranged. Accordingly, even in the case where deviation in drive timings for the transfer transistors 11A to 11D causes a problem, this configuration can suppress the difference in timing delay caused between the transfer transistors 11A to 11D, and prevent electric charges from leaking. Therefore, in the cases of using signals of the photodiodes 10A to 10D for phase difference focus detection and for generating a three-dimensional image utilizing parallax, correct signals can be acquired, which can achieve improvement in image quality and functionality of the solid state imaging device.

The arrangement of the contacts is not limited to that in the configuration described in the embodiments. Instead, another configuration may be adopted. Furthermore, the example of the circuit configuration of the pixel 3 is not limited to that in the configuration described in the embodiments. Instead, another configuration may be adopted. For instance, a configuration with a row selection transistor, and a configuration with an AD converter in the pixel 3 may be adopted. Moreover, the solid state imaging device is not limited to the surface irradiation solid state imaging device. Instead, the device may be a back irradiation solid state imaging device.

In the embodiments, “substantially” indicates the cases having a difference within five percent. Within three percent is more desirable. Within one percent is most desirable.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-194182, filed Sep. 4, 2012, which is hereby incorporated by reference herein in its entirety.

What is claimed is:

1. A solid state imaging device comprising:
a first photoelectric conversion unit configured to generate electric charges by photoelectric conversion;
a second photoelectric conversion unit configured to generate electric charges by photoelectric conversion;
an isolation portion configured to isolate the first photoelectric conversion unit from the second photoelectric conversion unit;
a first floating diffusion;
a second floating diffusion;
a first transfer transistor configured to transfer the electric charges generated by the first photoelectric conversion unit to the first floating diffusion;
a second transfer transistor configured to transfer the electric charges generated by the second photoelectric conversion unit to the second floating diffusion;
one or two transfer control lines configured to supply transfer pulses to each of the first and second transfer transistors;
one or two contacts configured to connect gates of the first and second transfer transistors with the one or two transfer control lines, wherein:
the first and second transfer transistors are arranged substantially symmetrically with respect to the isolation section;
the contacts are arranged substantially symmetrically with respect to the isolation portion;
values of parasitic capacitance and parasitic resistance of a path in which the transfer pulses are supplied from the transfer control lines to the first transfer transistor are substantially equal to values of parasitic capacitance and parasitic resistance of a path in which the transfer pulses are supplied from the transfer control lines to the second transfer transistor; and
a focus detection is performed using a signal based on the electric charges generated in the first photoelectric conversion unit and a signal based on the electric charges generated in the second photoelectric conversion unit.

2. The solid state imaging device according to claim 1,
wherein the transfer control line comprises two transfer control lines, and the two transfer control lines are arranged substantially symmetrically with respect to the isolation portion.

3. The solid state imaging device according to claim 1,
wherein the transfer control line comprises two transfer control lines, and
the device further comprises a switch that connects the two transfer control lines to each other.

4. The solid state imaging device according to claim 1,
wherein the transfer control line is one transfer control line,
the gate of the first transfer transistor and the gate of the second transfer transistor are connected to each other, and
the one transfer control line is connected to the gate of the first transfer transistor and the gate of the second transfer transistor.

5. The solid state imaging device according to claim 4,
wherein the contact is one contact, and
the one contact connects the one transfer control line to the gate of the first transfer transistor and the gate of the second transfer transistor.

6. The solid state imaging device according to claim 1, further comprising:
a third photoelectric conversion unit configured to generate electric charges by photoelectric conversion;
a fourth photoelectric conversion unit configured to generate electric charges by photoelectric conversion; a third floating diffusion; a fourth floating diffusion;
a third transfer transistor configured to transfer the electric charges generated by the third photoelectric conversion unit to the third floating diffusion; and
a fourth transfer transistor configured to transfer the electric charges generated by the fourth photoelectric conversion unit to the fourth floating diffusion,
wherein the first to fourth photoelectric conversion units are isolated by the isolation portion, and
the first to fourth transfer transistors are arranged substantially symmetrically with respect to the isolation portion.

7. The solid state imaging device according to claim 1, further comprising:
a first amplification transistor configured to have a gate connected to the first floating diffusion; and
a second amplification transistor configured to have a gate connected to the second floating diffusion.

8. The solid state imaging device according to claim 1,
wherein each of the first and second photoelectric conversion units comprises a first conductive type semiconductor region, and a second conductive type semiconductor region, and electric charges are accumulable in the second conductive type semiconductor region, and
the isolation portion comprises a first conductive type semiconductor region.

9. The solid state imaging device according to claim 1,
wherein one microlens is arranged for the first and second photoelectric conversion units.

10. The solid state imaging device according to claim 1,
wherein a height of a potential barrier of the isolation portion is lower than a height of a potential barrier of a region of the first and second transfer transistors below the gates of the first and second transfer transistors.

11. The solid state imaging device according to claim 1,
wherein the transfer pulses cause the first transfer transistor and the second transfer transistor to transition from an off level to an on level at a same timing, and, after a predetermined time period elapses, the pulses cause the transistors to transition from the on level to the off level at a same timing.
